(19) United States
(12) Patent Application Publication
(10) Pub. No.: US 2001/0009946 A1
(43) Pub. Date: Jul. 26, 2001

(54) POLYCARBONATE RESIN/GRAFT COPOLYMER BLENDS

(75) Inventors: PETER CATSMAN, BERGEN OP ZOOM (NL); LUC CARLOS GOVAERTS, BELSELE (BE); RICHARD LUCAS, BERGEN OP ZOOM (NL)

Correspondence Address: KEVIN E MCVEIGH, GE PLASTICS, ONE PLASTICS AVENUE, PITTSFIELD, MA, 01201

(73) Assignee: GENERAL ELECTRIC COMPANY

(21) Appl. No.: 09/162,567

(22) Filed: Sep. 29, 1998

(51) Int. Cl. C08G 63/48; C08L 51/00

(52) U.S. Cl. 525/67

(57) ABSTRACT

A thermoplastic resin composition contains a polycarbonate resin, a mass polymerized rubber modified graft copolymer that contains a discontinuous rubber phase dispersed in a continuous rigid thermoplastic phase, wherein at least a portion of the rigid thermoplastic phase is chemically grafted to the rubber and exhibits good processability, including a high melt flow rate, good physical properties, including good impact resistance, and improved resistance to edge cracking and to environmental stress cracking.

### FIELD OF THE INVENTION

The invention relates to polycarbonate resin/graft copolymer blends that exhibit improved resistance to cracking.

### BRIEF DESCRIPTION OF THE RELATED ART

Polycarbonate resin/graft copolymer compositions have, under certain circumstances, been found susceptible to cracking, specifically, edge cracking and environmental stress cracking. Edge cracking is a phenomenon, associated with certain processing conditions, which results in visible cracks on the edges of articles molded from the polycarbonate resin/graft copolymer blends. Environmental stress cracking is a phenomenon, associated with exposure of articles molded from polycarbonate resin/graft copolymer blends to certain environmental conditions, that results in visible cracks in the molded articles.

U.S. Pat. No. 5,672,645 (Eckel et. al.) discloses a flame resistant thermoplastic molding composition that are said to exhibit improved resistance to stress cracking. The composition disclosed by Eckel et. al contains an aromatic polycarbonate, a vinyl copolymer, a graft copolymer, a fluorinated polyolefin and from 0.5 to 20 parts by weight, based on 100 parts by weight of the thermoplastic molding composition, of a mixture of (i) from 10 percent by weight to 90 percent by weight, based on the weight of the mixture, of a monophosphorus compound according structural formula:

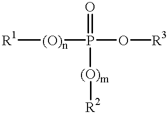

wherein R¹, R² and R³ are each independently optionally halogenated (C₁-C₈)alkyl, (C₆-C₂₀)aryl or (C₇-C₁₂)aralkyl, m is 0 or 1, and n is 0 or 1, and (ii) and an oligomeric phosphorus compound. It has been recognized, as disclosed in U.S. Pat. No. 5,204,394 (Gossens et. al.), that use of monophosphates, such as, for example, triphenyl phosphate, as flame retardants in polycarbonate resin/graft copolymer blends is associated with certain drawbacks, including “juicing”, that is, migration of triphenyl phosphate to the surface when the polycarbonate resin/graft copolymer blend is injection molded, as well as reduced thermal properties due to plasticization of the polycarbonate resin/graft copolymer blend by triphenyl phosphate.

Polycarbonate resin/graft copolymer blends that exhibit improved resistance to cracking, improved flow properties and improved processability, without suffering from the above-discussed deficiencies of juicing and compromised thermal properties, are desired. While the compositions disclosed in the above discussed references are flame retardant resin blends, applicants note that desire for improved properties extends to both flame retardant and non-flame retardant polycarbonate resin/graft copolymer blends.

### SUMMARY OF THE INVENTION

The present invention is directed to a thermoplastic resin composition that exhibits improved resistance to edge cracking.

In a first embodiment, the thermoplastic resin composition of the present invention comprises:

(a) an aromatic polycarbonate resin having an intrinsic viscosity of less than or equal to 55 milliliters per gram;

(b) a rubber modified graft copolymer comprising a discontinuous rubber phase dispersed in a continuous rigid thermoplastic phase, wherein at least a portion of the rigid thermoplastic phase is chemically grafted to the rubber phase, said rubber modified graft copolymer being made by a bulk polymerization process; and

(c) from 0 to 20 parts by weight, based on 100 parts by weight of the resin composition, of one or more organophosphorus flame retardant compounds, provided that if the resin composition comprises greater than or equal to 0.5 parts by weight organophosphorus flame retardant compounds, then such organophosphorus flame retardant compounds comprise, based on 100 parts by weight of organophosphorus flame retardant compounds, less than 10 parts by weight monophosphorus compounds of the structural formula:

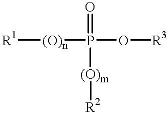

wherein:

R¹, R² and R³ are each independently optionally halogenated (C₁-C₈)alkyl, (C₆-C₂₀)aryl or (C₇-C₁₂)aralkyl,

m is 0 or 1, and

n is 0 or 1.

In a second aspect, the present invention is directed to method for improving the resistance to cracking of an article molded from blend of an aromatic polycarbonate resin and a graft copolymer, comprising using, as the graft copolymer of the blend, a graft copolymer comprising a discontinuous rubber phase dispersed in a continuous rigid thermoplastic phase, wherein at least a portion of the rigid thermoplastic phase is chemically grafted to the rubber, said rubber modified graft copolymer being made by a bulk polymerization process.

The composition of the present invention exhibits good processability, including a high melt flow rate, good physical properties, including good impact resistance, and improved resistance to edge cracking and to environmental stress cracking and do not exhibit the deficiencies of juicing and compromised thermal properties that have been found to be associated with the use of relatively high levels of monophosphate flame retardants.

### DETAILED DESCRIPTION OF THE INVENTION

In a first preferred embodiment, the composition of the present invention comprises, based on 100 parts by weight (“pbw”) the thermoplastic resin composition, from 40 to 96 pbw, more preferably from 50 to 90 pbw, even more preferably from 55 to 80 pbw of the aromatic polycarbonate resin, from 4 to 59 pbw, more preferably from 8 to 48 pbw, even more preferably from 14 to 39 pbw, of the rubber modified graft copolymer and from 0 to less than 0.5 pbw organophosphate flame retardant compounds.

In a second preferred embodiment, the composition of the present invention comprises, based on 100 pbw the thermoplastic resin composition, from 40 to 95.5 pbw, more preferably from 50 to 90 pbw, even more preferably from 55 to 80 pbw, of the aromatic polycarbonate resin, from 4 to 59 pbw more preferably from 8 to 48 pbw, even more preferably from 14 to 39 pbw, of the rubber modified graft copolymer and from 0.5 to 20 pbw, more preferably from 2 to 20 pbw, even more preferably from 6 to 15 pbw of the one or more organophosphate flame retardant compounds. In a more highly preferred embodiment, the organophosphate flame retardant compound component of the second preferred embodiment of the composition of the present invention comprises less than or equal to 8 pbw, more preferably less than or equal to 7 pbw, monophosphorus compounds according to the above disclosed structural formula per 100 pbw organophosphate flame retardant compound.

The intrinsic viscosity of the aromatic polycarbonate resin is measured in methylene chloride at 25° C. In a preferred embodiment, the aromatic polycarbonate resin exhibits an intrinsic viscosity of from 40 to 54 milliliters per gram (“ml/g”), more preferably of from 43 to 53 ml/g and even more preferably of from 45 to 52 ml/g. The aromatic polycarbonate resin component of the composition of the present invention may be a single aromatic polycarbonate resin having a viscosity within the disclosed range or may be a blend of two or more aromatic polycarbonate resin, each having a different respective viscosity, wherein the blend exhibits a viscosity within the disclosed range.

Aromatic polycarbonate resins suitable for use as the polycarbonate resin component of the thermoplastic resin composition of the present invention are known compounds whose preparation and properties have been described, see, generally, U.S. Pat. Nos. 3,169,121, 4,487,896 and 5,411,999, the respective disclosures of which are each incorporated herein by reference.

In a preferred embodiment, the aromatic polycarbonate resin component of the present invention is the reaction product of a dihydric phenol according to the structural formula (I):

HO—A—OH (I)

wherein A is a divalent aromatic radical, with a carbonate precursor and contains structural units according to the formula (II):

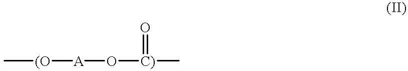

wherein A is defined as above.

As used herein, the term “divalent aromatic radical ” includes those divalent radicals containing a single aromatic ring such as phenylene, those divalent radicals containing a condensed aromatic ring system such as, for example, naphthlene, those divalent radicals containing two or more aromatic rings joined by a non-aromatic linkage, such as for example, an alkylene, alkylidene or sulfonyl group, any of which may be substituted at one or more sites on the aromatic ring with, for example, a halo group or (C₁-C₆)alkyl group.

In a preferred embodiment, A is a divalent aromatic radical according to the formula (XXI):

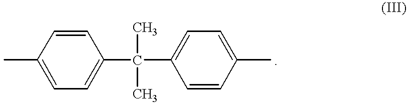

Suitable dihydric phenols include, for example, one or more of 2,2-bis-(4-hydroxyphenyl) propane (“bisphenol A”), 2,2-bis(3,5-dimethyl-4-hydroxyphenyl)propane, bis(4-hydroxyphenyl) methane, 4,4-bis(4-hydroxyphenyl)heptane, 3,5,3′,5′-tetrachloro-4,4′-dihydroxyphenyl)propane, 2,6-dihydroxy naphthalene, hydroquinone, 2,4′-dihydroxyphenyl sulfone. In a highly preferred embodiment, the dihydric phenol is bisphenol A.

The carbonate precursor is one or more of a carbonyl halide, a carbonate ester or a haloformate. Suitable carbonyl halides include, for example, carbonyl bromide and carbonyl chloride. Suitable carbonate esters include, such as for example, diphenyl carbonate, dichlorophenyl carbonate, dinaphthyl carbonate, phenyl tolyl carbonate and ditolyl carbonate. Suitable haloformates include, for example, bishaloformates of a dihydric phenols, such as, for example, hydroquinone, or glycols, such as, for example, ethylene glycol, neopentyl glycol. In a highly preferred embodiment, the carbonate precursor is carbonyl chloride.

Suitable aromatic polycarbonate resins include linear aromatic polycarbonate resins, branched aromatic polycarbonate resins. Suitable linear aromatic polycarbonates resins include, e.g., bisphenol A polycarbonate resin. Suitable branched polycarbonates are known and are made by reacting a polyfunctional aromatic compound with a dihydric phenol and a carbonate precursor to form a branched polymer, see generally, U.S. Pat. Nos. 3,544,514, 3,635,895 and 4,001,184, the respective disclosures of which are incorporated herein by reference. The polyfunctional compounds are generally aromatic and contain at least three functional groups which are carboxyl, carboxylic anhydrides, phenols, haloformates or mixtures thereof, such as, for example, 1,1,1-tri(4-hydroxyphenyl)ethane, 1,3,5,-trihydroxy-benzene, trimellitic anhydride, trimellitic acid, trimellityl trichloride, 4-chloroformyl phthalic anhydride, pyromellitic acid, pyromellitic dianhydride, mellitic acid, mellitic anhydride, trimesic acid, benzophenonetetracarboxylic acid, benzophenone-tetracarboxylic dianhydride. The preferred polyfunctional aromatic compounds are 1,1,1-tri(4-hydroxyphenyl)ethane, trimellitic anhydride or trimellitic acid or their haloformate derivatives.

In a preferred embodiment, the polycarbonate resin component of the present invention is a linear polycarbonate resin derived from bisphenol A and phosgene.

Polycarbonate resins are made by known methods, such as, for example, interfacial polymerization, transesterification, solution polymerization or melt polymerization.

Copolyester-carbonate resins are also suitable for use as the aromatic polycarbonate resin component of the present invention. Copolyester-carbonate resins suitable for use as the aromatic polycarbonate resin component of the thermoplastic resin composition of the present invention are known compounds whose preparation and properties have been described, see, generally, U.S. Pat. Nos. 3,169,121, 4,430,484 and 4,487,896, the respective disclosures of which are each incorporated herein by reference.

Copolyester-carbonate resins comprise linear or randomly branched polymers that contain recurring carbonate groups, carboxylate groups and aromatic carbocyclic groups in the polymer chain, in which at least some of the carbonate groups are bonded directly to the ring carbon atoms of the aromatic carbocyclic groups.

In a preferred embodiment, the copolyester-carbonate resin component of the present invention is derived from a carbonate precursor, at least one dihydric phenol and at least one dicarboxylic acid or dicarboxylic acid equivalent. In a preferred embodiment, the dicarboxylic acid is one according to the formula (IV):

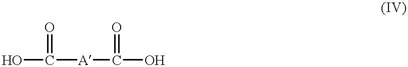

wherein A′ is alkylene, alkylidene, cycloaliphatic or aromatic and is preferably a non-substituted phenylene radical or a substituted phenylene radical that is substituted at one or more sites on the aromatic ring, wherein each of such substituent groups is independently (C₁-C₆) alkyl, and the copolyester carbonate resin comprises first structural units according to formula (II) above and second structural units according to formula (V):

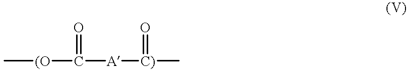

wherein A′ is defined as above.

Suitable carbonate precursors and dihydric phenols are those disclosed above.

Suitable dicarboxylic acids, include, for example, phthalic acid, isophthalic acid, terephthalic acid, dimethyl terephthalic acid, oxalic acid, malonic acid, succinic acid, glutaric acid, adipic acid, pimelic acid, suberic acid, azelaic acid, sebacic acid, dimethyl malonic acid, 1,12-dodecanoic acid, cis-1,4-cyclohexane dicarboxylic acid, trans-1,4-cyclohexane dicarboxylic acid, 4,4′-bisbenzoic acid, naphthalene-2,6-dicarboxylic acid. Suitable dicarboxylic acid equivalents include, for example, anhydride, ester or halide derivatives of the above disclosed dicarboxylic acids, such as, for example, phthalic anhydride, dimethyl terephthalate, succinyl chloride.

In a preferred embodiment, the dicarboxylic acid is an aromatic dicarboxylic acid, more preferably one or more of terephthalic acid and isophthalic acid.

In a preferred embodiment, the ratio of ester bonds to carbonate bonds present in the copolyester carbonate resin is from 0.25 to 0.9 ester bonds per carbonate bond.

Copolyester-carbonate resins are made by known methods, such as, for example, interfacial polymerization, transesterification, solution polymerization or melt polymerization.

Rubber modified thermoplastic resins suitable for use as the rubber modified thermoplastic resin of the present invention are those rubber modified thermoplastic resins that are made by a bulk or, synonymously, mass, polymerization process and that comprise a discontinuous rubber phase dispersed in a continuous rigid thermoplastic phase, wherein at least a portion of the rigid thermoplastic phase is chemically grafted to the rubber phase.

Bulk polymerization processes for making rubber modified graft copolymers are well known in the art, see, for example, U.S. Pat. Nos. 2,646,418; 3,243,481; 4,254,236 and 5,414,045, the disclosures of which are each hereby incorporated by reference herein.

In a preferred embodiment, the rubber modified thermoplastic resin is made by a bulk polymerization process that is carried out in a series of polymerization reactors consecutively connected to each other to provide a series of reaction zones. A rubber, for example, a styrene-butadiene rubber, is dissolved in one or more of the monomers from which the rigid thermoplastic phase of the graft copolymer is to be derived, for example, styrene monomer or styrene and acrylonitrile monomers, to form a reaction mixture that is fed to the reactor system and the reaction mixture is subjected to polymerization conditions. Polymerization of the monomers of the reaction mixture may be chemically or thermally initiated. The viscosity of the reaction mixture increases during the course of the polymerization reaction and a rigid thermoplastic phase, for example, a styrene-acrylonitrile (“SAN”) copolymer, is formed, a portion of which is chemically grafted to the rubber and a portion of which is not grafted to the rubber. At some point in the reaction, the reaction mixture separates to form two phases, that is, a continuous rubber solution phase and a discontinuous non-grafted rigid thermoplastic phase dispersed in the rubber solution phase. As the polymerization reaction progresses, the rubber solution phase begins to disperse in the growing rigid thermoplastic phase and, eventually, a “phase inversion” occurs wherein non-grafted rigid thermoplastic phase becomes the continuous phase and the rubber solution phase becomes a discontinuous phase dispersed in the non-grafted rigid thermoplastic phase. Typically, a third phase is also present, in that during the phase inversion some non-grafted rigid thermoplastic phase becomes occluded within the discontinuous rubber solution phase. Following the phase inversion, the polymerization reaction is continued and more non-grafted rigid thermoplastic phase is formed. The reaction mixture is then subjected to more aggressive reaction conditions to drive the reaction to a desired level, typically in the range of 60 to 90%, of monomer conversion. The reaction produces a rubber phase and a rigid thermoplastic phase, at least a portion of which is grafted to the rubber phase. The product is then devolatilized to remove any residual unreacted monomers and solvent.

Suitable rubbers for use in making the rubber phase are polymers those having a glass transition temperature (T_{g}) of less than or equal to 25° C., more preferably less than or equal to 0° C., and even more preferably less than or equal to −30° C. As referred to herein, the T_{g} of a polymer is the T_{g} value of polymer as measured by differential scanning calorimetry (heating rate 20° C/minute, with the T_{g} value being determined at the inflection point).

In a preferred embodiment, the rubber comprises a linear polymer having structural units derived from one or more conjugated diene monomers.

Suitable conjugated diene monomers include, e.g., 1,3-butadiene, isoprene, 1,3-heptadiene, methyl-1,3-pentadiene, 2,3-dimethylbutadiene, 2-ethyl-1,3-pentadiene, 1,3-hexadiene, 2,4, hexadiene, dichlorobutadiene, bromobutadiene and dibromobutadiene as well as mixtures of conjugated diene monomers. In a preferred embodiment, the conjugated diene monomer is 1,3-butadiene.

The rubber may, optionally, include structural units derived from one or more copolymerizable monoethylenically unsaturated monomers selected from (C₂-C₈)olefin monomers, vinyl aromatic monomers and monoethylenically unsaturated nitrile monomers and (C₁-C₁₂)alkyl (meth)acrylate monomers.

As used herein, the term “(C₂-C₈)olefin monomers” means a compound having from 2 to 8 carbon atoms per molecule and having a single site of ethylenic unsaturation per molecule. Suitable (C₂-C₈)olefin monomers include, e.g., ethylene, propene, 1-butene, 1-pentene, heptene.

Suitable vinyl aromatic monomers include, e.g., styrene and substituted styrenes having one or more alkyl, alkoxyl, hydroxyl or halo substituent group attached to the aromatic ring, including, e.g., α-methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, e.g., vinyl naphthalene, vinyl anthracene, as well as mixtures of vinyl aromatic monomers.

As used herein, the term “monoethylenically unsaturated nitrile monomer” means an acyclic compound that includes a single nitrile group and a single site of ethylenic unsaturation per molecule and includes, e.g., acrylonitrile, methacrylonitrile, α-chloro acrylonitrile.

As used herein, the term “(C₁-C₁₂)alkyl” means a straight or branched alkyl substituent group having from 1 to 12 carbon atoms per group and includes, e.g., methyl, ethyl, n-butyl, sec-butyl, t-butyl, n-propyl, iso-propyl, pentyl, hexyl, heptyl, octyl, nonyl, decyl, undecyl and dodecyl, and the terminology “(meth)acrylate monomers” refers collectively to acrylate monomers and methacrylate monomers. Suitable (C₁-C₁₂)alkyl (meth)acrylate monomers include (C₁-C₁₂)alkyl acrylate monomers, e.g., ethyl acrylate, butyl acrylate, iso-pentyl acrylate, n-hexyl acrylate, 2-ethyl hexyl acrylate, and their (C₁-C₁₂)alkyl methacrylate analogs such as, e.g., methyl methacrylate, ethyl methacrylate, propyl methacrylate, iso-propyl methacrylate, butyl methacrylate, hexyl methacrylate, decyl methacrylate.

In a first preferred embodiment, the rubber is a polybutadiene homopolymer.

In an alternative preferred embodiment, the rubber is a copolymer, preferably a block copolymer, comprising structural units derived from one or more conjugated diene monomers and up to 50 percent by weight (“wt %”) structural units derived from one or more monomers selected from vinyl aromatic monomers and monoethylenically unsaturated nitrile monomers, such as, for example, a styrene-butadiene copolymer, an acrylonitrile-butadiene copolymer or a styrene-butadiene-acrylonitrile copolymer.

In a highly preferred embodiment, the rubber is a styrene-butadiene block copolymer that contains from 50 to 95 wt % structural units derived from butadiene and from 5 to 50 wt % structural units derived from styrene.

The rigid thermoplastic resin phase comprises one or more thermoplastic polymers and exhibits a T_{g} of greater than 25° C., preferably greater than or equal to 90° C. and even more preferably greater than or equal to 100° C.

In a preferred embodiment, the rigid thermoplastic phase comprises one or more polymers each having structural units derived from one or more monomers selected from the group consisting of (C₁-C₁₂)alkyl (meth)acrylate monomers, vinyl aromatic monomers and monoethylenically unsaturated nitrile monomers.

Suitable vinyl aromatic monomers and monoethylenically unsaturated nitrile monomers and of (C₁-C₁₂)alkyl (meth)acrylate monomers are those set forth above in the description of the rubber phase.

In a preferred embodiment, the rigid thermoplastic resin phase comprises a vinyl aromatic polymer having first structural units derived from one or more vinyl aromatic monomers, preferably styrene, and having second structural units derived from one or more monoethylenically unsaturated nitrile monomers, preferably acrylonitrile. More preferably, the rigid phase comprises from 55 to 99 wt %, still more preferably 60 to 90 wt %, structural units derived from styrene and from 1 to 45 wt %, still more preferably 10 to 40 wt %, structural units derived from acrylonitrile.

The amount of grafting that takes place between the rigid thermoplastic phase and the rubber phase varies with the relative amount and composition of the rubber phase. In a preferred embodiment, from 10 to 90 wt %, preferably from 25 to 60 wt %, of the rigid thermoplastic phase is chemically grafted to the rubber phase and from 10 to 90 wt %, preferably from 40 to 75 wt % of the rigid thermoplastic phase remains “free, i.e., non-grafted.

The rigid thermoplastic phase of the rubber modified thermoplastic resin may be formed: (i) solely by polymerization carried out in the presence of the rubber phase or (ii) by addition of one or more separately polymerized rigid thermoplastic polymers to a rigid thermoplastic polymer that has been polymerized in the presence of the rubber phase.

In a preferred embodiment, the rubber modified thermoplastic resin comprises an rubber phase comprising a polymer having structural units derived from one or more conjugated diene monomers, and, optionally, further comprising structural units derived from one or more monomers selected from vinyl aromatic monomers and monoethylenically unsaturated nitrile monomers, and the rigid thermoplastic phase comprises a polymer having structural units derived from one or more monomers selected from vinyl aromatic monomers and monoethylenically unsaturated nitrile monomers.

In a highly preferred embodiment, the rubber phase of the rubber modified graft copolymer comprises a polybutadiene or poly(styrene-butadiene) rubber and the rigid phase comprises a styrene-acrylonitrile copolymer.

Each of the polymers of the rubber phase and of the rigid thermoplastic resin phase of the rubber modified thermoplastic resin may, provided that the T_{g} limitation for the respective phase is satisfied, optionally include structural units derived from one or more other copolymerizable monoethylenically unsaturated monomers such as, e.g., monoethylenically unsaturated carboxylic acids such as, e.g., acrylic acid, methacrylic acid, itaconic acid, hydroxy(C₁-C₁₂)alkyl (meth)acrylate monomers such as, e.g., hydroxyethyl methacrylate; (C₄-C₁₂)cycloalkyl (meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides, maleic anhydride, vinyl esters such as, e.g., vinyl acetate and vinyl propionate. As used herein, the term “(C₄-C₁₂)cycloalkyl” means a cyclic alkyl substituent group having from 4 to 12 carbon atoms per group and the term “(meth)acrylamide” refers collectively to acrylamides and methacrylamides.

In a preferred embodiment, the rubber phase of rubber modified thermoplastic resin has a particle size of from 0.1 to 3.0 micrometers (“μm”) more preferably from 0.2 to 2.0 μm.

In a preferred embodiment, the composition of the present invention includes a fluoropolymer, in an amount, typically from 0.01 to 0.5 pbw fluoropolymer per 100 pbw of the thermoplastic resin composition, that is effective to provide anti-drip properties to the resin composition. Suitable fluoropolymers and methods for making such fluoropolymers are known, see, e.g., U.S. Pat. Nos. 3,671,487, 3,723,373 and 3,383,092. Suitable fluoropolymers include homopolymers and copolymers that comprise structural units derived from one or more fluorinated α-olefin monomers. The term “fluorinated α-olefin monomer” means an α-olefin monomer that includes at least one fluorine atom substituent. Suitable fluorinated α-olefin monomers include, e.g., fluoroethylenes such as, e.g., CF₂═CF₂, CHF═CF₂, CH₂═CF₂, CH₂═CHF, CClF═CF₂, CCl₂═CF₂, CClF═CClF, CHF═CCl₂, CH₂═CClF, and CCl₂═CClF and fluoropropylenes such as, e.g., CF₃CF═CF₂, CF₃CF═CHF, CF₃CH═CF₂, CF₃CH═CH₂, CF₃CF═CHF, CHF₂CH═CHF and CF₃CH═CH₂. In a preferred embodiment, the fluorinated α-olefin monomer is one or more of tetrafluoroethylene (CF₂═CF₂), chlorotrichloroethylene (CClF═CF₂), vinylidene fluoride (CH₂═CF₂) and hexafluoropropylene (CF₂═CFCF₃).

Suitable fluorinated α-olefin homopolymers include e.g., poly(tetra-fluoroethylene), poly(hexafluoroethylene).

Suitable fluorinated α-olefin copolymers include copolymers comprising structural units derived from two or more fluorinated α-olefin copolymers such as, e.g., poly(tetrafluoroethylene-hexafluoroethylene), and copolymers comprising structural units derived from one or more fluorinated monomers and one or more non-fluorinated monoethylenically unsaturated monomers that are copolymerizable with the fluorinated monomers such as, e.g., poly(tetrafluoroethylene-ethylene-propylene) copolymers. Suitable non-fluorinated monoethylenically unsaturated monomers include e.g., α-olefin monomers such as, e.g., ethylene, propylene butene, acrylate monomers such as e.g., methyl methacrylate, butyl acrylate, vinyl ethers, such as, e.g., cyclohexyl vinyl ether, ethyl vinyl ether, n-butyl vinyl ether, vinyl esters such as, e.g., vinyl acetate, vinyl versatate.

In a preferred embodiment, the fluoropolymer particles range in size from 50 to 500 nm, as measured by electron microscopy.

In a highly preferred embodiment, the fluoropolymer is a poly(tetrafluoroethylene) homopolymer (“PTFE”).

Since direct incorporation of a fluoropolymer into a thermoplastic resin composition tends to be difficult, it is preferred that the fluoropolymer be pre-blended in some manner with a second polymer, such as for, example, an aromatic polycarbonate resin or a styrene-acrylonitrile resin. For example, an aqueous dispersion of fluoropolymer and a polycarbonate resin may be steam precipitated to form a fluoropolymer concentrate for use as a drip inhibitor additive in thermoplastic resin composition, as disclosed in, for example, U.S. Pat. No. 5,521,230, or, alternatively, an aqueous styrene-acrylonitrile resin emulsion or an aqueous acrylonitrile-butadiene-styrene resin emulsion and then precipitating and drying the co-coagulated fluoropolymer-thermoplastic resin composition to provide a PTFE-thermoplastic resin powder as disclosed in, for example, U.S. Pat. No. 4,579,906.

In a preferred embodiment, the fluoropolymer additive comprises from 30 to 70 wt %, more preferably 40 to 60 wt %, of the fluoropolymer and from 30 to 70 wt %, more preferably 40 to 60 wt %, of the second polymer.

In a preferred embodiment, a fluoropolymer additive is made by emulsion polymerization of one or more monoethylenically unsaturated monomers in the presence of the aqueous fluoropolymer dispersion of the present invention to form a second polymer in the presence of the fluoropolymer. Suitable monoethylenically unsaturated monomers are disclosed above. The emulsion is then precipitated, e.g., by addition of sulfuric acid. The precipitate is dewatered, e.g., by centrifugation, and then dried to form a fluoropolymer additive that comprises fluoropolymer and an associated second polymer. The dry emulsion polymerized fluoropolymer additive is in the form of a free-flowing powder.

In a preferred embodiment, the monoethylenically unsaturated monomers that are emulsion polymerized to form the second polymer comprise one or more monomers selected from vinyl aromatic monomers, monoethylenically unsaturated nitrile monomer and (C₁-C₁₂)alkyl (meth)acrylate monomers. Suitable vinyl aromatic monomers, monoethylenically unsaturated nitrile monomer and (C₁-C₁₂)alkyl (meth)acrylate monomers are disclosed above.

In a highly preferred embodiment, the second polymer comprises structural units derived from styrene and acrylonitrile. More preferably, the second polymer comprises from 60 to 90 wt % structural units derived from styrene and from 10 to 40 wt % structural units derived from acrylonitrile.

The emulsion polymerization reaction mixture may optionally include emulsified or dispersed particles of a third polymer, such as, e.g., an emulsified butadiene rubber latex.

The emulsion polymerization reaction is initiated using a conventional free radical initiator such as, e.g., an organic peroxide compound, such as e.g., benzoyl peroxide, a persulfate compound, such as, e.g., potassium persulfate, an azonitrile compound such as, e.g., 2,2′-azobis-2,3,3-trimethylbutyronitrile, or a redox initiator system, such as, e.g., a combination of cumene hydroperoxide, ferrous sulfate, tetrasodium pyrophosphate and a reducing sugar or sodium formaldehyde sulfoxylate.

A chain transfer agent such as, e.g., a (C₉-C₁₃) alkyl mercaptan compound such as nonyl mercaptan, t-dodecyl mercaptan, may, optionally, be added to the reaction vessel during the polymerization reaction to reduce the molecular weight of the second polymer. In a preferred embodiment, no chain transfer agent is used.

In a preferred embodiment, the stabilized fluoropolymer dispersion is charged to a reaction vessel and heated with stirring. The initiator system and the one or more monoethylenically unsaturated monomers are then charged to the reaction vessel and heated to polymerize the monomers in the presence of the fluoropolymer particles of the dispersion to thereby form the second polymer.

Suitable fluoropolymer additives and emulsion polymerization methods are disclosed in EP 0 739 914 A1.

In a preferred embodiment, the resin composition of the present invention comprises, based on 100 pbw of the thermoplastic resin composition, a total amount of from 0 to 1.5 pbw, more preferably from 0 to 1 pbw, of chlorine and bromine. Even more preferably, the thermoplastic resin composition contains substantially no, that is, no more than a trace amount, of chlorine and bromine and even more preferably, contains no chlorine or bromine.

In a preferred embodiment, the second polymer exhibits a weight average molecular weight of from about 10,000 to about 200,000 g/mol.

Organophosphorus compounds suitable as the organophosphorus flame retardant of the present invention are known compounds including monophosphate esters such as, for example, triphenyl phosphate, tricresyl phosphate, tritolyl phosphate, diphenyl tricresylphosphate, phenyl bisdodecyl phosphate, ethyl diphenyl phosphate, as well as diphosphate esters and oligomeric phosphates such as, for example, resorcinol diphosphate, diphenyl hydrogen phosphate, 2-ethylhexyl hydrogen phosphate. Suitable oligomeric phosphate compounds are set forth in coassigned U.S. Pat. No. 5,672,645, to Johannes C. Gossens et al for a “Polymer Mixture Having Aromatic Polycarbonate, Styrene Containing Copolymer and/or Graft Copolymer and a Flame Retardant, Articles Formed Therefrom”, the disclosure of which is hereby incorporated herein by reference.

In a preferred embodiment, the organophosphorus flame retardant of the present invention comprises one or more compounds according to the structural formula (VI):

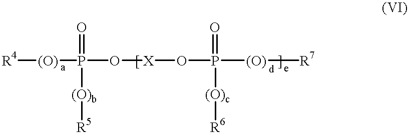

wherein R⁴, R⁵, R⁶ and R⁷ are each independently alkyl, aryl or aralkyl, each of which may be optionally substituted with halo or alkyl,

X is arylene, optionally substituted with halo or alkyl,

a, b, c and d are each independently 0 or 1, and

e is an integer of from 0 to 5, more preferably from 1 to 5.

As used herein, aryl means a monovalent radical containing one or more aromatic rings per radical, which, in the case wherein the radical contains two or more rings, may be fused rings and which may optionally be substituted on the one or more aromatic rings with one or more alkyl groups, each preferably (C₁-C₆)alkyl.

As used herein, arylene means a divalent radical containing one or more aromatic rings per radical, which may optionally be substituted on the one or more aromatic rings with one or more alkyl groups, each preferably (C₁-C₆)alkyl and which, in the case wherein the divalent radical contains two or more rings, the rings may be may be fused or may be joined by a non-aromatic linkages, such as for example, an alkylene, alkylidene, any of which may be substituted at one or more sites on the aromatic ring with a halo group or (C₁-C₆)alkyl group.

In a highly preferred embodiment, R⁴, R⁵, R⁶ and R⁷ are each phenyl, a, b, c and d are each 1 and X is phenylene, more preferably 1,3-phenylene.

In an alternative highly preferred embodiment, embodiment R⁴, R⁵, R⁶ and R⁷ are each phenyl, a, b, c and d are each 1 and X is a divalent radical according to the structural formula (VII):

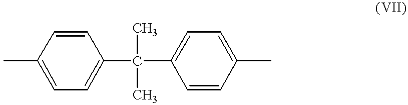

In preferred embodiment, the organophosphorus flame retardant comprises a blend of organophosphorus oligomers, each according to formula (VI), wherein e is, independently for each oligomer, an integer from 1 to 5 and wherein the blend of oligomers has an average e of from greater than 1 to less than 5, more preferably greater than 1 to less than 3, even more preferably greater than 1 to less than 2, still more preferably from 1.2 to 1.7.

The thermoplastic resin composition of the present invention may optionally also contain various conventional additives, such as antioxidants, such as, e.g., organophosphites, e.g., tris(nonyl-phenyl)phosphite, (2,4,6-tri-tert-butylphenyl)(2-butyl-2-ethyl-1,3-propanediol)phosphite, bis(2,4-di-t-butylphenyl)pentaerythritol diphosphite or distearyl pentaerythritol diphosphite, as well as alkylated monophenols, polyphenols, alkylated reaction products of polyphenols with dienes, such as, e.g., butylated reaction products of para-cresol and dicyclopentadiene, alkylated hydroquinones, hydroxylated thiodiphenyl ethers, alkylidene-bisphenols, benzyl compounds, acylaminophenols, esters of beta-(3,5-di-tert-butyl-4-hydroxyphenol)-propionic acid with monohydric or polyhydric alcohols, esters of beta-(5-tert-butyl-4-hydroxy-3-methylphenyl)-propionic acid with monohydric or polyhydric alcohols, esters of beta-(5-tert-butyl-4-hydroxy-3-methylphenyl) propionic acid with mono-or polyhydric alcohols, esters of thioalkyl or thioaryl compounds, such as, e.g., distearylthiopropionate, dilaurylthiopropionate, ditridecylthiodipropionate, amides of beta-(3,5-di-tert-butyl-4-hydroxyphenol)-propionic acid; UV absorbers and light stabilizers such as, e.g., (i) 2-(2′-hydroxyphenyl)-benzotriazoles, 2-Hydroxy-benzophenones; (ii) esters of substituted and unsubstituted benzoic acids, (iii) acrylates, (iv) sterically hindered amines such as, e.g., triisopropanol amine or the reaction product of 2,4-dichloro-6-(4-morpholinyl)-1,3,5-triazine with a polymer of 1,6-diamine, N, N′-Bis(-2,2,4,6-tetramethyl-4-piperidenyl) hexane; neutralizers such as magnesium stearate, magnesium oxide, zinc oxide, zinc stearate, hydrotalcite; impact modifiers, such as, for example a composite rubber impact modifier comprising a polyorganosiloxane/polyalkyl (meth)acrylate composite rubber graft copolymer, known as Metablen S-2001, available from Mitsubishi Rayon; fillers and reinforcing agents, such as, e.g., silicates, TiO₂, glass fibers, carbon black, graphite, calcium carbonate, talc, mica; and other additives such as, e.g., lubricants such as, e.g., pentaerythritol tetrastearate, EBS wax, silicone fluids, plasticizers, optical brighteners, pigments, dyes, colorants, flameproofing agents; anti-static agents; and blowing agents, as well as other flame retardants in addition to the above-disclosed organophosphorus flame retardant and fluoropolymer.

The thermoplastic resin composition of the present invention is made by combining and mixing the components of the composition of the present invention under conditions suitable for the formation of a blend of the components, such as for example, by melt mixing using, for example, a two-roll mill, a Banbury mixer or a single screw or twin-screw extruder, and, optionally, then reducing the composition so formed to particulate form, e.g., by pelletizing or grinding the composition.

The thermoplastic resin composition of the present invention can be molded into useful shaped articles by a variety of means such as injection molding, extrusion, rotational molding, blow molding and thermoforming to form articles such as, for example, computer and business machine housings, or home appliances.

### EXAMPLES 1-9 AND COMPARATIVE EXAMPLES C1-C9

The thermoplastic resin compositions of Examples 1-10 of the present invention and of Comparative Examples C1-C9 were each made by combining the components described below in the relative amounts (each expressed in parts by weight) set forth below in TABLES I, II, V and VI. Each of the polycarbonate resins were linear aromatic polycarbonate resins derived from bisphenol A and phosgene. The intrinsic viscosity (“IV”)of each of the polycarbonate resins was measured in methylene chloride at 25° C. and are expressed in milliliters per gram (“ml/g”). PC-54, PC-53, PC-52 and PC-50 and PC-49 were each blends of a linear aromatic polycarbonate resin having an IV of 58.5 ml/g and a linear aromatic polycarbonate resin having an IV of 47.0 ml/g. PC-45 was a blend of a linear aromatic polycarbonate resin having an IV of 47.0 ml/g and a linear aromatic polycarbonate resin having an IV of 43.0 ml/g. The components used in the thermoplastic resin compositions were as follows:

| | |
|---|---|
| PC-54: | Polycarbonate resin having an IV of about 54 ml/g; |
| PC-53: | Polycarbonate resin having an IV of about 53 ml/g; |
| PC-52: | Polycarbonate resin having an IV of about 51.7 ml/g; |
| PC-50: | Polycarbonate resin having an IV of about 50 ml/g; |
| PC-49: | Polycarbonate resin having an IV of about 49.3 ml/g; |
| PC-47: | Polycarbonate resin having an IV of about 47 ml/g; |
| PC-45: | Polycarbonate resin having an IV of about 45 ml/g; |
| ABS-E: | Emulsion polymerized acrylonitrile-butadiene-styrene graft |
| | copolymer comprising 50 wt % of a discontinuous |
| | polybutadiene |
| | rubber phase and 50 wt % of a rigid styrene-acrylonitrile |
| | thermoplastic phase (copolymer of 75 wt % styrene |
| | and 25 wt % acrylonitrile); |
| ABS-B1: | Mass polymerized acrylonitrile-butadiene-styrene graft |
| | copolymer (SANTAC ™ AT-05, Mitsui Chemical Industries, |
| | Ltd.); |
| ABS-B2 | Mass polymerized acrylonitrile-butadiene-styrene graft |
| | copolymer (MAGNUM ™ 3513, Dow Chemical Company); |
| SAN: | Copolymer of 75 wt % styrene and 25 wt % acrylonitrile; |
| TSAN: | Additive made by copolymerizing styrene and acrylonitrile in |
| | the presence of an aqueous dispersion of PTFE (50 |
| | pbw PTFE, 50 pbw of a styrene-acrylonitrile copolymer |
| | containing 75 wt % styrene and 25 wt % acrylonitrile); and |
| RDP | Resorcinol diphosphate having a monophosphorus compound |
| | content of less than 10 wt % (Fyroflex ™ RDP, |
| | Akzo Chemicals). |

Each of the thermoplastic resin compositions of Examples 1-10 and Comparative Examples 1-9 had a total bromine and chlorine content of less than about 0.1 percent by weight.

The physical properties of the compositions of Examples 1-4 and Comparative Example C1 were measured as follows. Melt volume ratio (“MVR”) was measured at 260° C. using a 2.16 kilogram weight. Notched Izod impact strength was measured according to ISO 180. Vicat B temperature was measured according to ISO 306 at a heating rate 120° C. per hour. The flame retardant properties of the compositions were measured according to UL 94-V0.

Test specimens of the compositions of Examples 1-4 and Comparative Example C1-C4 were molded and subjected to edge crack testing. The specimens used for edge crack testing were shaped like a rectangular box having outside dimensions of 42 cm long, 9 cm wide and 2.5 cm deep, with a wall thickness of 3.0 mm for main sections of the specimen. The specimen was originally designed for use as a front cover for a compact disk player and also contained a several apertures on the front face of the specimen, such as openings for mounting buttons and displays and an opening to allow passage of a compact disk, as well as other features, such as snap-fit connector members, bosses and internal reinforcing ribs at various locations. The mold for making the test specimen was filled through two gates, each located near the center of a respective one of the 42 cm×2.5 cm walls of the part. The specimens were then aged at 100° C. for 3 hours. Edge cracks were identified by visual examination and marked with water soluble marker. The number and length of cracks were recorded. Cracking, when present, tended to occur along the terminal edges of the 3.0 mm thick walls.

Results of the testing for Examples 1-4 and Comparative Examples C1-C4 are set forth below in TABLES I and II as follows: MVR, expressed in milliliters per 10 minutes (“ml/10 min.”), total edge crack length, expressed in millimeters, (“mm”), notched Izod impact strength at 23° C., expressed in kilojoules per square meter (“kJ/m²”), Vicat B temperature, expressed in degrees Centigrade (“° C.”), and UL 94-V0 rating, expressed as “Pass” or “Fail”.

TABLE I

| | C1 | 1 | C2 | 2 |
|---|---|---|---|---|
| PC-54 | 73.09 | 73.09 | — | — |
| PC-52 | — | | 73.09 | 73.09 |
| ABS-E | 6.5 | — | 6.5 | — |
| ABS-B1 | — | 15.5 | — | 15.5 |
| SAN | 9.0 | — | 9.0 | — |
| RDP | 9.5 | 9.5 | 9.5 | 9.5 |
| TSAN | 0.5 | 0.5 | 0.5 | 0.5 |
| Additives | 1.41 | 1.41 | 1.41 | 1.41 |
| MVR (ml/10 min) | 10.80 | 12.8 | 14.2 | 14.9 |
| Total edge crack length (mm) | 0.0 | 0.0 | 7.7 | 0.2 |
| UL 94 | Pass | Pass | Pass | Pass |
| Vicat B (° C.) | 105.3 | 104.7 | 106.0 | 104.0 |
| Notched Izod Impact (kJ/m²) | 30.1 | 43.8 | 11.7 | 28.7 |

TABLE II

| | C3 | 3 | C4 | 4 |
|---|---|---|---|---|
| PC-49 | 73.09 | 73.09 | — | — |
| PC-47 | — | — | 73.09 | 73.09 |
| ABS-E | 6.5 | — | 6.5 | — |
| ABS-B1 | — | 15.5 | — | 15.5 |
| SAN | 9.0 | — | 9.0 | — |
| RDP | 9.5 | 9.5 | 9.5 | 9.5 |
| TSAN | 0.5 | 0.5 | 0.5 | 0.5 |
| Additives | 1.41 | 1.41 | 1.41 | 1.41 |
| MVR (ml/10 min) | 19.60 | 20.97 | 24.7 | 25.5 |
| Total edge crack length (mm) | 17.0 | 0.9 | 33.7 | 0.0 |
| UL 94 | Pass | Pass | Pass | Pass |
| Vicat B (° C.) | 103.3 | 103.4 | 103.0 | 103.5 |
| Notched Izod Impact (kJ/m²) | 10.1 | 23.3 | 16.0 | 19.7 |

The compositions of Examples 1-4 each exhibited improved resistance to edge cracking compared to the analogous one of the compositions of Comparative Example C1-C4, as evidenced by the reduced edge crack length. The edge cracking results exhibited by the compositions of Examples 1-4 appear to be insensitive to the molecular weight, within the range tested, of the aromatic polycarbonate resin, which allows the use of compositions having a relatively high range of melt flow rate without increased edge cracking.

The resistance of each of the compositions of Examples 1-4 and Comparative Example C5 to environmental stress induced cracking was determined. The composition of Comparative example C5 was substantially the same as that of Comparative example C1. Impact specimens (ISO dimensions b=4 mm, h=10 mm, l=80 mm) were molded from each of the compositions and then preconditioned for 16 hours at 80° C. The resistance to environmental stress cracking was then determined as follows. A specimen was placed in a sample holder of the type used in measurement of heat distortion temperature (specimen was supported across two supports that were disposed parallel to each other and spaced 64 mm apart) and the sample. A weighted probe was applied to the specimen at a point about midway between the supports to stress the specimen. The stress in megaPascals (“MPa”), load in Newtons (“N”) and in grams (“g”) and probe weight in kilograms (‘kg”) for the stress levels used (Stress Levels A-F) are each set forth below in TABLE III.

TABLE III

| Stress Level | Stress (MPa) | Load (N) | Load (g) | Probe Weight (kg) |
|---|---|---|---|---|
| A | 5.88 | 9.8 | 998 | 900 |
| B | 6.00 | 10.0 | 1019 | 920 |
| C | 6.25 | 10.4 | 1062 | 964 |
| D | 6.50 | 10.8 | 1104 | 1010 |
| E | 6.75 | 11.3 | 1147 | 1050 |
| F | 12.50 | 20.5 | 2094 | 2000 |

Each of the stressed specimens was then immersed in a container of cumene. The elapsed time from immersion of the stressed specimen in cumene to cracking of the specimen was recorded. The results are set forth below in TABLE IV as the time elapsed between immersion and cracking, in seconds (“s”).

TABLE IV

Elapsed Time (s)

| | C5 | 1 | 2 | 3 | 4 |
|---|---|---|---|---|---|
| Stress Level | | | | | |
| A | >120 | — | — | — | — |
| B | >120 | — | — | — | — |
| C | >120 | >120 | >120 | >120 | >120 |
| D | 8 | — | — | — | — |
| F | 9 | — | — | — | — |
| F | — | >120 | >120 | >120 | >120 |

The compositions of Examples 1-4 each showed improved resistance to stress cracking compared to the composition of Comparative Example C5, as evidenced by the lack of stress cracking after 120 seconds under the test conditions.

The MVR, Izod impact strength of the compositions of Comparative Examples C6-C9 and Examples 5-10 were measured by the methods described above. The “critical stress”, defined as the highest stress level at which the specimen remains unbroken after 120 second immersion of the stressed specimen in cumene, was measured using the method described above. Results are set forth below in TABLEs V and VI as MVR, expressed in milliliters per gram (“ml/g”), impact strength at room temperature, expressed in kilojoules per square meter (“kJ/m²”) and critical stress, expressed in MegaPascals (“Mpa”).

TABLE V

| | C6 | C7 | C8 | C9 |
|---|---|---|---|---|
| PC53 | 61.1 | — | — | — |
| PC50 | — | 61.1 | — | — |
| PC47 | — | — | 61.1 | — |
| PC45 | — | — | — | 61.1 |
| ABS-E | 16 | 16 | 16 | 16 |
| SAN | 19 | 19 | 19 | 19 |
| Additives | 3.9 | 3.9 | 3.9 | 3.9 |
| MVR (ml/10 min) | 13.3 | 18.2 | 25.9 | 33.6 |
| Izod Impact, RT (kJ/m²) | 49.4 | 44.5 | 40.5 | 38.1 |
| Critical Stress (MPa) | 3.75 | <3.5 | 3.5 | 3.75 |

TABLE VI

| | 5 | 6 | 7 | 8 | 9 | 10 |
|---|---|---|---|---|---|---|
| PC-53 | 61.1 | — | — | — | — | — |
| PC-50 | — | 61.1 | — | — | — | — |
| PC-47 | — | — | 61.1 | — | 61.1 | |
| PC-45 | — | — | — | 61.1 | — | 61.1 |
| ABS-B1 | 35 | 35 | 35 | 35 | — | — |
| ABS-B2 | — | — | — | — | 35 | 35 |
| Additives | 3.9 | 3.9 | 3.9 | 3.9 | 3.9 | 3.9 |
| MVR (ml/10 min) | 28.2 | 35.8 | 47.6 | 59.3 | 27.8 | 35.2 |
| Izod Impact, RT (kJ/m²) | 72 | 66.4 | 52.2 | 41.5 | 48.2 | 40.2 |
| Critical Stress (MPa) | >6.25 | >6.25 | >6.25 | >6.2S | 4 | 4.5 |

The compositions of Examples 5-10 each exhibited improved MVR, Izod impact strength and critical stress compared to the closest corresponding composition of Comparative Examples C6-C9.

The composition of the present invention exhibits good processability, including a high melt flow rate, good physical properties, including good impact resistance, and improved resistance to edge cracking and to environmental stress cracking.

1. A thermoplastic resin composition, comprising:
(a) an aromatic polycarbonate resin having an intrinsic viscosity of less than or equal to 55 milliliters per gram;
(b) a rubber modified graft copolymer comprising a discontinuous rubber phase dispersed in a continuous rigid thermoplastic phase, wherein at least a portion of the rigid thermoplastic phase is chemically grafted to the rubber phase, said rubber modified graft copolymer being made by a bulk polymerization process; and
(c) from 0 to 20 parts by weight, based on 100 parts by weight of the resin composition, of one or more organophosphorus flame retardant compounds, provided that if the resin composition comprises greater than or equal to 0.5 parts by weight organophosphorus flame retardant compounds, then such organophosphorus flame retardant compounds comprise, based on 100 parts by weight of organophosphorus flame retardant compounds, less than 10 parts by weight monophosphorus compounds of the structural formula: 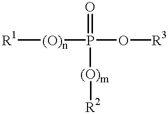
wherein:
R¹, R² and R³ are each independently optionally halogenated (C₁-C₈)alkyl, (C₆-C₂₀)aryl or (C₇-C₁₂)aralkyl,
m is 0 or 1, and
n is 0 or 1.

2. The composition of claim 1, wherein the aromatic polycarbonate resin comprises one or more linear polycarbonate resins, each derived from bisphenol A and phosgene.

3. The composition of claim 1, wherein the aromatic polycarbonate resin exhibits an intrinsic viscosity of from 40 milliliters per gram to 54 milliliters per gram.

4. The composition of claim 1, wherein the rubber phase comprises a polybutadiene polymer or a poly(styrene-butadiene) copolymer and the rigid thermoplastic phase comprises structural units derived from one or more monomers selected from vinyl aromatic monomers and a monoethylenically unsaturated nitrile monomers.

5. The composition of claim 4, wherein rigid phase comprises a copolymer of derived from monomers selected from the group consisting of styrene, a-methyl styrene and acrylonitrile.

6. The composition of claim 1, wherein the composition comprises, based on 100 parts by weight the thermoplastic resin composition, from 40 to 96 parts by weight of the aromatic polycarbonate resin, from 4 to 59 parts by weight of the rubber modified graft copolymer and from 0 to less than 0.5 parts by weight organophosphate flame retardant compounds.

7. The composition of claim 6, wherein the composition comprises less than 0.05 parts by weight organophosphate flame retardant compounds per 100 parts by weight the thermoplastic resin composition.

8. The composition of claim 1, wherein the composition comprises, based on 100 parts by weight the thermoplastic resin composition, from 40 to 95.5 parts by weight of the aromatic polycarbonate resin, from 4 to 59 parts by weight of the rubber modified graft copolymer and from 0.5 to 20 parts by of the organophosphate flame retardant compounds.

9. The composition of claim 8, wherein the organophosphorus flame retardant compounds comprise one or more compounds according to the structural formula: 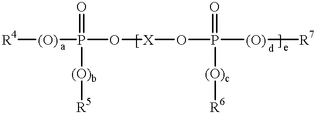
wherein R⁴, R⁵, R⁶ and R⁷ are each independently alkyl, aryl or aralkyl, each of which may be optionally substituted with halo or alkyl,
X is arylene, optionally substituted with halo or alkyl,
a, b, c and d are each independently 0 or 1, and
e is an integer of from 0 to 5.

10. The composition of claim 8, wherein the composition further comprises a fluoropolymer, in an amount effective to provide anti-drip properties to the composition.

11. An article made by molding the composition of claim 1.

12. A method for improving the resistance of an article molded from blend of an aromatic polycarbonate resin and a graft copolymer to edge cracking, comprising using, as the graft copolymer of the blend, a graft copolymer comprising a discontinuous rubber phase dispersed in a continuous rigid thermoplastic phase, wherein at least a portion of the rigid thermoplastic phase is chemically grafted to the rubber, said rubber modified graft copolymer being made by a bulk polymerization process.

13. The composition of claim 12, wherein the aromatic polycarbonate resin comprises one or more linear polycarbonate resins, each derived from bisphenol A and phosgene.

14. The composition of claim 12, wherein the aromatic polycarbonate resin exhibits an intrinsic viscosity of less than 55 milliliters per gram.

15. The method of claim 12, wherein the rubber phase comprises a polybutadiene polymer or a poly(styrene-butadiene) copolymer and the rigid thermoplastic phase comprises structural units derived from one or more monomers selected from vinyl aromatic monomers and a monoethylenically unsaturated nitrile monomers.
